(19) United States
(12) Patent Application Publication
(10) Pub. No.: US 2011/0177420 A1
(43) Pub. Date: Jul. 21, 2011

(54) FUEL CELL STACK SYSTEM HAVING MULTIPLE SUB-STACKS THAT ARE REPLACEABLE ONLINE

(75) Inventors: Ronald H. Wolk, Santa Clara, CA (US); Iouri I. Balachov, San Mateo, CA (US); J. Robert Selman, Chicago, IL (US)

(73) Assignee: 4D Power, LLC, Menlo Park, CA (US)

(21) Appl. No.: 12/695,839

(22) Filed: Jan. 28, 2010

Related U.S. Application Data
(63) Continuation of application No. 12/688,228, filed on Jan. 15, 2010.

(51) Int. Cl. H01M 8/24

(52) U.S. Cl. 429/471

(57) ABSTRACT

A fuel cell stack system having multiple sub-stacks that are replaceable online is disclosed. In one aspect of the present disclosure, the fuel cell stack system includes multiple fuel cell sub-stacks electrically coupled to one another, the multiple fuel cell sub-stacks include multiple fuel cells electrically coupled to one another enclosed in a sub-stack vessel. Each of the multiple fuel cells can include a composite cathode element and an anode chamber coupled to the composite cathode element. In one embodiment, each of the multiple fuel cell sub-stacks is replaceable online.

### CLAIM OF PRIORITY

This application is a Continuation-In-Part application of co-pending U.S. patent application Ser. No. 12/688,228 [Attorney Docket No. 71328-8002.US03], entitled “A FUEL CELL STACK SYSTEM HAVING MULTIPLE SUB-STACKS THAT ARE REPLACEABLE ONLINE”, filed Jan. 15, 2010, the contents of which are expressly incorporated by reference herein.

### TECHNICAL FIELD

The techniques are generally related to devices for electrochemical conversion for electrical energy generation, in particular, to fuel cell device structures for ease of fuel injection, modularity, and integration. Some embodiments of the fuel cell device structures are suited for use with carbon-rich fuels.

### BACKGROUND

An advantage of a fuel cell is its ability to generate electricity in an environmentally friendly manner with higher efficiency than combustion technologies. Major disadvantages of fuel cells are the high cost of the premium fuels that they require and insecurity about future supplies of those fuels. These disadvantages present barriers to commercial success of fuel cell technology. Fuel cell technology, which has both features: (1) fuel security and (2) ability to generate electricity at a competitive cost would have a better chance for commercial success. Fuel cells operating on hydrogen are slowly fading away from consideration for widespread commercial applications because of technical problems and costs related to hydrogen production, storage, and transportation. Fuel cells that require natural gas reforming to produce hydrogen which increases system cost and, eventually the cost of electricity. Cost of electricity will become even higher, if natural gas prices increase in the future.

### BRIEF DESCRIPTION OF THE DRAWINGS

FIG. 1 illustrates a cross sectional view of a composite cathode element that is vertically oriented or oriented such that dispersion of injected fuel throughout the fuel cell anode is caused at least in part by buoyancy force.

FIG. 2 illustrates a cross sectional view of a portion of a fuel cell with cathode elements oriented such that dispersion of injected fuel throughout the fuel cell anode is caused at least in part by buoyancy force.

FIG. 3 depicts examples of the cathode and anode current collectors.

FIG. 4 diagrammatically depicts an example reaction in a fuel cell using a mixture of oxygen and carbon dioxide as oxidizer gas and carbonate ion conductive electrolyte.

FIG. 5 diagrammatically depicts an example reaction in a fuel cell using oxygen as oxidizer gas and carbonate ion conductive electrolyte.

FIG. 6 diagrammatically depicts another example reaction in a fuel cell using oxygen as oxidizer gas and oxide ion conductive electrolyte.

FIG. 7 illustrates a cross sectional view of a fuel cell sub-stack having multiple cathode and anode collectors electrically coupled to one another in parallel.

FIG. 8 illustrates a diagrammatic view of a fuel cell sub-stack.

FIG. 9 illustrates a diagrammatic view of a fuel cell sub-stack showing the fuel and oxidizer supplies.

FIG. 10 illustrates a diagrammatic view of a fuel cell sub-stack having a thermal insulation.

FIG. 11 illustrates a diagrammatic view of a fuel cell stack having multiple sub-stacks that are replaceable online.

FIG. 12 illustrates a diagrammatic view of a fuel cell stack integrated into a stand-alone power generator.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include fuel cells having cathode elements oriented such that dispersion of injected fuel through the fuel cell anode is caused at least in part by buoyancy force. Proposed technology is particularly applicable to low cost carbon containing solid and heavy liquid fuels that can be easily dispersed in the anode system. Examples of such fuels are: biomass, waste derived fuels, coal, coke, and heavy oil. The disclosed fuel cells and fuel cell stacks are advantageous for the at least following reasons:

The disclosed fuel cell structure utilizes a cathode which allows operation below 800° C. with preferred operating temperature of 650° C. Lowering the operating temperature would decrease the severity of any molten salt corrosion taking place and would reduce the tendency for the reverse Boudouard reaction to take place and thereby reduce cell efficiency. Commonly the reverse Boudouard reaction takes place at carbon in contact with CO₂ containing gas phase: C+CO₂=2CO, but it can also take place at carbon in contact with carbonate melt:

C+CO₃²⁻→2CO+O²⁻

Both the gas-phase reaction and the reaction with the melt accelerate with increasing temperature in the range of 600-800° C. To be sustained, the reverse Boudouard consumption of carbon by the melt requires neutralization of the oxide ion by CO₂. This is helped by the relatively high CO₂ solubility in the melt which is only weakly dependent on temperature. Therefore in a stirred melt (by gas sparging or by the carbon dioxide bubbles produced by electrochemical oxidation of carbon) neutralization occurs easily and above 700° C. carbon consumption occurs continually by the reverse Boudouard reaction which may become the predominant mode of oxidation.

The disclosed fuel cell structure can utilize thin, high surface area cathode plates. Because of the much higher surface to volume ratio, this has the potential to markedly increase flow of oxidizing ions into the anode, thereby increasing power density.

The anode comprises molten medium with dispersed fuel and anode current collector.

The disclosed fuel cell structure can process feed stocks containing sulfur (because product gas is recycled only to the anode and ash/mineral matter such as insoluble sulfides (iron and light-metal sulfides) can be removed from each sub-stack.)

The disclosed fuel cell structure can use one or a few fuel injection ports, and product gas and ash/mineral matter removal lines for each sub-stack. The 2-dimensional scale-up simplifies the design, compared to the case where each individual cell would require its own removal ports and feed lines. The disclosed fuel cell structure can also allow the designer freedom to adjust the horizontal distances between plates to allow for different feed stocks which may have differing reactivities and therefore require greater or lesser residence time in the anode zone.

In addition, the disclosed fuel cell structure has longer reaction zones due to height to width aspect ratio of the anode compartments, thereby decreasing the extent of the reverse Boudouard reaction in each cell, and the risk of lowering its efficiency. The disclosed fuel cell structure has the possibility of including a pyrolysis zone and thereby allows the use of feedstocks with some volatile components. Fuel gases produced in the pyrolysis zone will pass upwardly through the anode zone and be converted electrochemically to electricity.

Gaseous products formed in the anode may be transported to a molten carbonate sub-stack within the same or other stack to be consumed as fuel.

Moreover, the disclosed fuel cell structure can include a fuel mixing and distribution zone, that is, a liquid plenum below the lower end of the composite cathode/electrolyte plates, which can be designed to re-distribute particles injected into the molten salt plenum so that their concentration in the various anode compartment of the sub-stack is sufficiently uniform. In one embodiment, evaporated molten salt can be replenished by injection of dry salt mixed with fuel into the anode chamber.

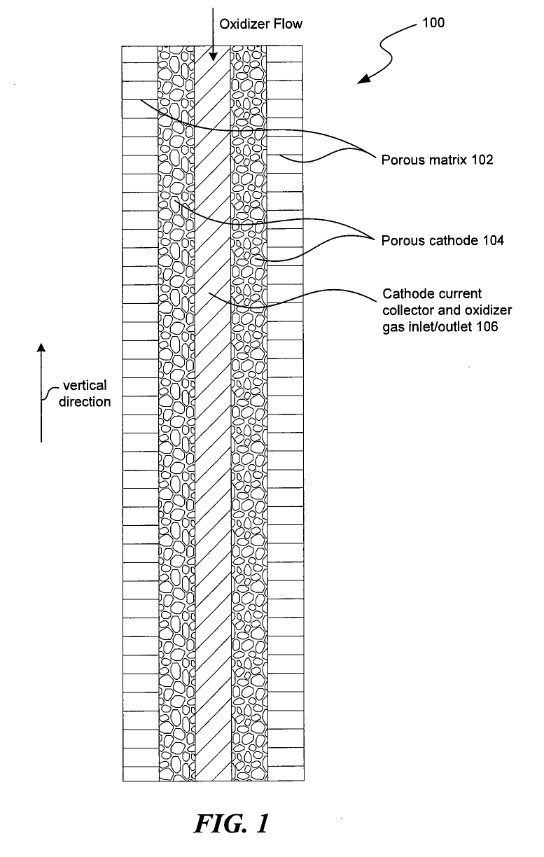

FIG. 1 illustrates a cross sectional view of a composite cathode element 100 that is vertically oriented or oriented such that dispersion of injected fuel throughout the fuel cell anode is caused at least in part by buoyancy force.

The composite cathode element 100 of a fuel cell can include a porous matrix 102, a cathode 104, and/or a cathode current collector 106. In one embodiment, the cathode element 100 is oriented such that dispersion of injected fuel throughout the fuel cell anode is caused at least in part by buoyancy force. For example, the composite cathode element 100 can be vertically oriented such that they are substantially parallel to the line of gravity (e.g., 0-10 degrees from the line of gravity). Alternatively, the composite cathode element 100 may also be 10-15 degrees, 15-20 degrees, 20-30 degrees, 30-45 degrees, or 45-75 degrees, etc.

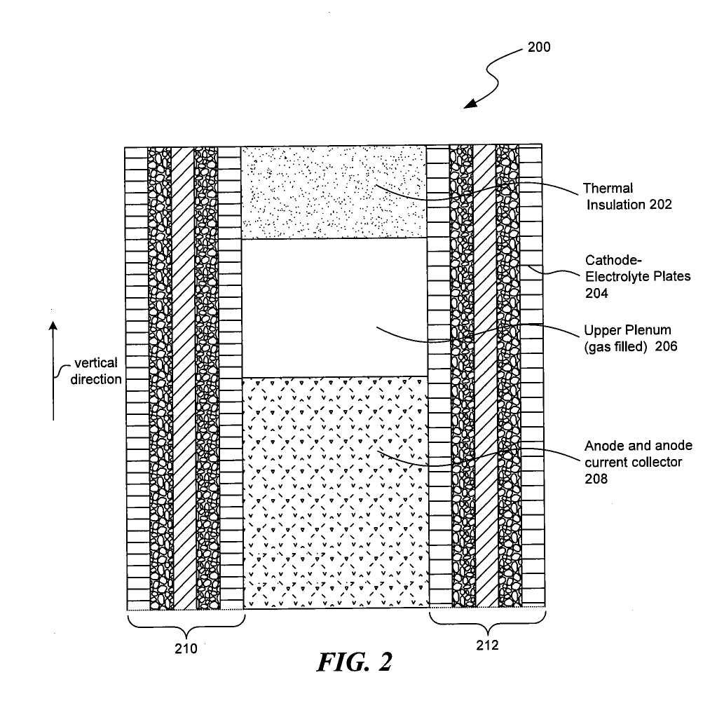

A fuel cell with the composite cathode element 100 as a repeating element is illustrated with further reference to the example of FIG. 2. The porous matrix 102 can be made of ceramic material and holds molten salt electrolyte such as carbonate mixtures. Typically, the composition of the molten salt filling the porous matrix would consist of eutectic mixtures of alkali- and alkali-earth carbonates.

The geometry of the composite cathode element 100 can be tubular with a closed end since the tubular geometry can eliminate the need for high temperature sealing. Alternatively, a planar structure (e.g., rectangular) may be used with a plate edge sealant. If a tubular element is used, its cross section may be circular, elliptical, rectangular, rounded rectangular, hexagonal, or any other closed two-dimensional shape.

The cathode 104 is generally porous and may be partially filled by gas and/or partially filled by melt. In one embodiment, oxidizer gas enters cathode compartment and passes through the cathode current collector structure. The composite cathode element 100, is in one embodiment, vertically oriented (as illustrated in FIG. 1) in the fuel cell device and may be doubled sided which comprises two porous matrices and two cathodes on each side of the cathode current collector. Each cathode element can be as large as approximately 60 cm wide (typical width of tape casting machines) and approximately 90 cm in height although other dimensions may also be used. The cathode elements are aligned in parallel or near parallel with a typical distance between plates in the range of 1-5 cm or other distances.

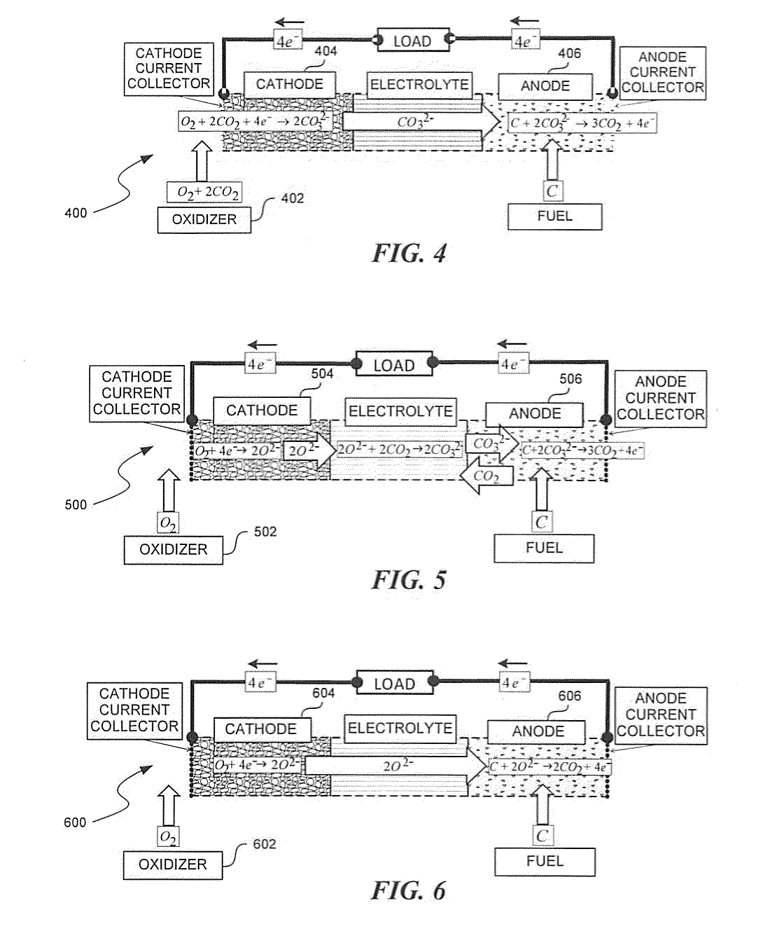

The vertical orientation of the composite cathode element 100 facilitates ease of fuel injection since the fuel can be injected to the bottom of element 100 and dispersed via buoyancy action. The vertical orientation also allows the bubbles or carrier gas formed during fuel oxidation to rise upwards in the composite cathode element 100 to facilitate mixing with the molten salt that is in the anode chamber (e.g., the anode chamber 208 in the example of FIG. 2). In other instances, the composite cathode element 100 may also be diagonally oriented. The choice of materials for the cathode 104 depends on the type of oxidizer gas and oxidizer ion and is further described with references to the examples of FIG. 4-6.

In one embodiment, the composite cathode element is formed by two cathode plates welded together. The two cathode plates may be plates such as those used in a molten carbonate fuel cell (MCFC) system or other types of fuel cell systems. For example, the two cathode plates may comprise substantially of porous nickel. During operation of the fuel cell, the porous nickel can convert to lithiated nickel oxide.

FIG. 2 illustrates a cross sectional view of a portion of a fuel cell 200 with vertically arranged cathode elements 210 and 212.

The fuel cell 200 generates DC electricity by conversion of the chemical energy in the carbon-rich fuel into electricity via electrochemical oxidation of carbon in the anode chamber 208 (e.g., anode zone). In general, the fuel cell 200 includes the anode chamber 208, an anode current collector, electrolyte, the cathode elements 210 and/or 212, and the cathode current collector. In one embodiment, the anode chamber 208 separates a cathode element 210 from another cathode element 212. The cathode elements 210 enclose a cathode structure. The anode chamber 208 is disposed between the composite cathode elements 210 and 212. In one embodiment, the anode chamber 208 comprises molten medium, fuel particles, current collector and optional solid particles that are electrically conductive dispersed therein and can generally be of any shape and/or form. For example, the anode chamber may be circular or tubular.

In one embodiment, the anode chamber 20 is also oriented such that dispersion of injected fuel through the fuel cell is caused at least in part by buoyancy force. For example, the anode chamber 20 can be vertically oriented such that they are substantially parallel to the line of gravity (e.g., 0-10 degrees from the line of gravity). Alternatively, the anode chamber 20 may also be 10-15 degrees, 15-20 degrees, 20-30 degrees, 30-45 degrees, or 45-75 degrees, etc.

During operation, the fuel that is injected in to the fuel cell 200 is oxidized in the anode chamber 208 by oxidizer ions generated at the composite cathode element 210 and transported to the anode chamber 208 via the electrolyte in the porous matrix. The electrolyte also serves as a gas tight barrier between the anode chamber 208 and cathode element 210 and/or 212. The cathode current collector supplies electrons required for electrochemical reduction of oxidizer gas and the electrons can be transported to the cathode current collector via an external load. The anode current collector in the anode chamber 208 transports electrons generated by fuel oxidation reaction to an external load and then to the cathode current collector, thus completing an electrical circuit. The operating temperature is typically 650° C. with possibility to operate at temperatures below 800° C. The melting point of the molten salt used in the cathode element 208 and in the salt anode slurry is typically at least 50-100° C. below the operating temperature.

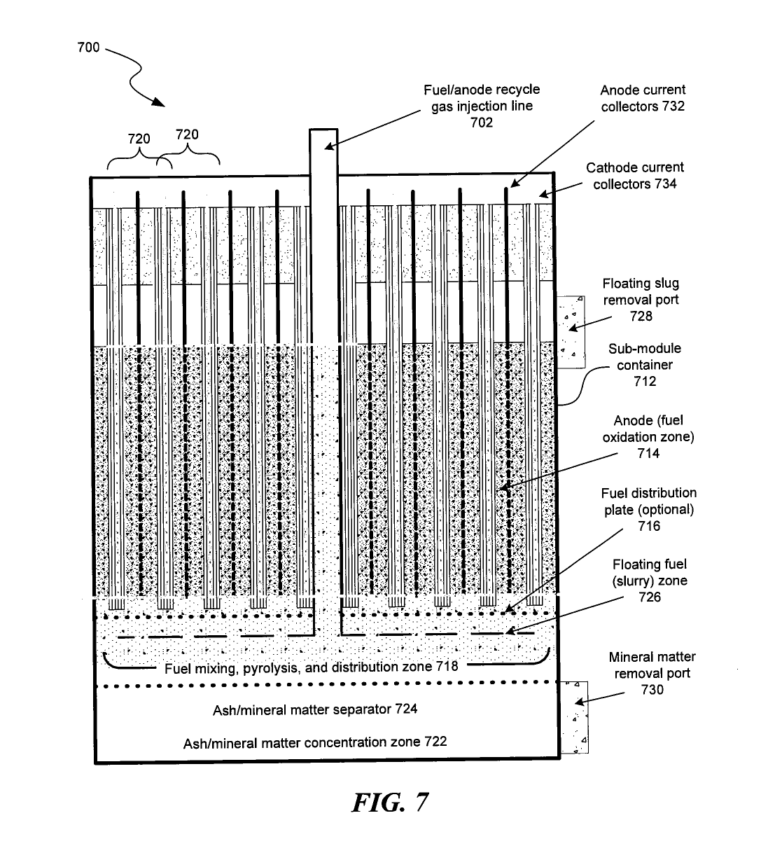

The fuel is typically injected into the anode chamber 208 via carrier gas (e.g., through a fuel injection line illustrated in the example of FIG. 7) which may be inert (e.g., nitrogen) or may form complex oxidizer ions. For example, when the carrier gas is CO₂ it can react with oxidizing ions (O²⁻) to form a complex oxidizing ion (CO₃²⁻) Injected fuel particles rise inside the anode chamber 208 between two neighboring vertical cathode/electrolyte plates because they are less dense than the molten salt. Rising bubbles of carrier gas and buoyancy forces will cause motion and mixing of fuel particles within the molten salt in the anode chamber 208.

The anode chamber 208 further comprises an anode current collector to transport electrons generated from oxidation of the fuel to the cathode current collector in the cathode elements 210 and/or 212. The anode current collector can be comprised of conductive material including but not limited to graphite, stainless steel, gold, and/or silver. Additionally, the anode current collector is generally corrosion resistant. In one embodiment, surface area of the anode current collector is increased to achieve mixed conductivity in the anode chamber. For example, one embodiment of the anode current collector includes a serpentine mesh. The fuel cell 200 is preferably a direct carbon fuel cell containing a molten carbonate anode.

In general, the anode chamber 208 includes a mixed conductor with ratio of electronic to ionic conductivity on the order of approximately 5:1. Pure carbonate molten salts conduct CO₃²⁻ ions and do not conduct electrons efficiently. Similarly, oxide ion conductive solids and melts conduct only O²⁻ and do not conduct electrons efficiently. Therefore, sufficient electronic conductivity of the fuel-containing molten salt anode slurry can be achieved by one (or a combination) of the following techniques:
1. Use a dense three-dimensional current collector, for example a metal foam of very large porosity and pore size. If the current collector is two-dimensional, for example, a metal screen, multiple screens must be used with the spacing between adjacent screens reduced, in combination with selecting appropriate mesh size, to obtain the desired effective (volumetric) electronic conductivity. In case if non-conductive fuel is used, this arrangement allows to connect individual cells in a sub-stack in series and reduce ohmic losses.
2. Disperse electronically conductive but electrochemically inert particles in the slurry as a stable suspension enhancing the stochastic particle-to-particle conduction in the fuel slurry. The solid particles, of necessarily small size to achieve a stable dispersion, must have high bulk electronic conductivity. Using particles with high aspect ratio can allow achieving a sufficient effective conductivity of the slurry with a lower volumetric content of particles. Such particles should have density close to density of molten salt to prevent segregation or precipitation. Examples of inert but well-conducting solids that can be used for this purpose include by way of example but not limitation, carbides and nitrides of boron and calcium.
3. Use fuel that has a naturally high electronic conductivity. For example, solid fuels rich in carbon of high electronic conductivity (e.g., graphitic carbons) may be used. The match of fuel reactivity and its electronic conductivity can be carefully considered to maximize power density.
4. Optimize the volumetric content of fuel dispersed in the molten salt anode slurry. According to percolation theory, increasing the volumetric content of a solid electronically conductive phase in a liquid electronically insulating phase generally does not necessarily result in a gradual increase in bulk electronic conductivity, but rather may cause a stepwise increase, especially at low volume fractions of the conducting phase. This effect depends strongly on the size and aspect ratio of the conducting particles. This must be taken into account when defining the optimal volumetric content of fuel in the liquid anode. From an economic viewpoint, cost optimization can include the cost of reducing fuel particle size by pulverization if necessary to achieve a desirable level of performance.

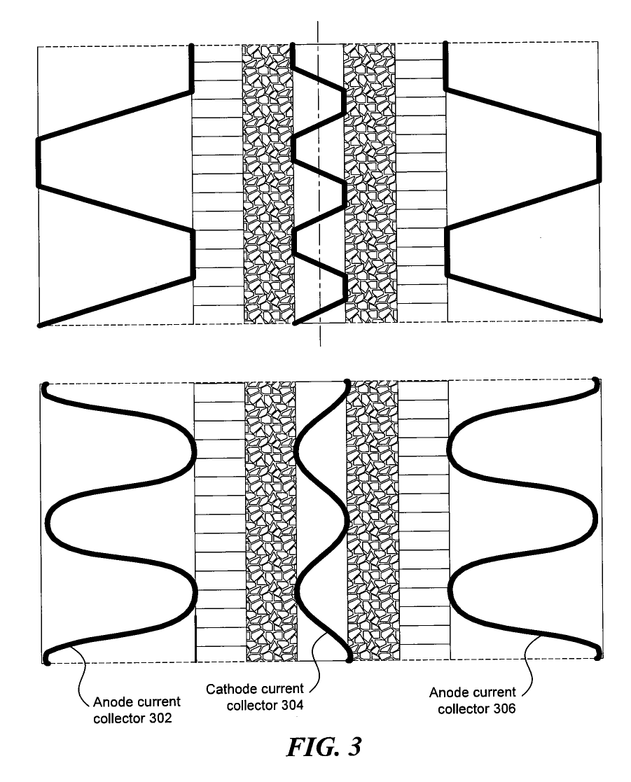

FIG. 3 depicts examples of the cathode 304 and anode current collectors 302.

One embodiment of the anode 302 and cathode current collectors 304 are formed with ribbed and/or serpentine structures. Such geometry can facilitate fuel and oxidizer flow around the collector. The anode and cathode current collectors are designed to operate under balanced mechanical pressure so as to establish the desired electrical contact between metal and ceramics, while preventing one-sided mechanical stresses, which may lead to cracking of ceramic components.

FIG. 4 diagrammatically depicts an example reaction 400 in a fuel cell using a mixture of oxygen and carbon dioxide as oxidizer gas 402.

In the example reaction 400 of the fuel cell (e.g., direct carbon fuel cell), the oxidizer gas 402 includes a mixture of oxygen and carbon dioxide. The material of the cathode 404 can include nickel oxide, alternatives including but not limited to lithium cobaltate. In general, the cathode 404 material can include any material suitable for use in a molten carbonate fuel cell.

The source of CO₂ gas in this reaction can depend on the purity of the fuel used. For example, if the fuel contains no impurities, that end up in gaseous form and may corrode or damage the catalytic properties of the cathode 404, such as sulfur or chlorine, anode effluent may be used to recycle CO₂ from the anode 406 to the cathode 404. In case the fuel contains impurities, which may end up in a damaging gaseous form, anode CO₂ cannot be recycled to the cathode and CO₂ has to be supplied from an external source, as illustrated.

The reaction at the cathode 404 is the reduction of a gas mixture containing O₂ (or air) and CO₂ with consumption of four electrons and generation of two complex oxidizer ions (CO₃²⁻). Oxidizer ions are transported from the cathode 404 to the anode 406 by the molten salt in the composite cathode-electrolyte element. The molten salt used in the fuel cell can include alkali or/and alkali-earth molten carbonates held in the porous ceramic matrix by capillary forces. In one embodiment, evaporated molten salt is replenished by injection of dry salt mixed with fuel into the anode chamber.

Upon exiting the composite cathode element, oxidizer ions will encounter and oxidize fuel particles electrochemically with release of four electrons and three molecules of CO₂. The molten salt selected for the molten salt anode slurry may be the same or somewhat different from that in the electrolyte, as needed for high conductivity during fuel cell operation.

FIG. 5 diagrammatically depicts an example reaction 500 in a fuel cell using oxygen as oxidizer gas.

In the example reaction 500 of the fuel cell (e.g., direct carbon fuel cell), the oxidizer gas 502 contains only oxygen (or air). Transport of the oxide ions from the cathode 504 to the fuel containing anode slurry takes place in a liquid medium, such as molten carbonate. The material of the cathode 504 can include nickel oxide, alternatives including but not limited to lithium cobaltate, and/or lanthanum strontium manganite.

In this type of reaction, CO₂ gas does not need to be supplied to the cathode 504. The reaction at the cathode 504 includes the reduction of oxygen with consumption of four electrons and generation of two O²⁻ ions, which are converted in electrolyte to oxidizer ions CO₃²⁻ in reaction with CO₂ and which are transported to the fuel in the molten salt anode slurry. In this case, electrolyte and anode materials are the same as in reaction 400 illustrated in the example of FIG. 4.

The molten salt electrolyte can include alkali or/and alkaline-earth molten carbonates held in a porous ceramic matrix by capillary forces. The electrolyte can also include carbon-rich solid fuel particles and/or oxide ion conductive melts. The O²⁻ ions generated at the cathode 504 can be converted into CO₃²⁻ ions by reaction with CO₂ in the molten salt adjacent to the composite cathode/electrolyte interface, or in the molten salt near the molten salt/anode current collector interface. The molten salt to be used for the molten salt anode slurry in this case is selected for high conductivity of the oxidizing ion, CO₃².

Upon entering the anode compartment 506, the oxidizer ions (CO₃²⁻) encounter solid fuel particles and oxidize those fuel particles electrochemically with release of four electrons and three molecules of CO₂. The CO₂ needed for conversion of O²⁻ ions into CO₃²⁻ ions is available as a product of the carbon oxidation reaction in the molten salt anode slurry, or as a carrier gas of the fuel injected into the anode compartment, which is subsequently dissolved in the molten salt anode slurry.

The cathode can be comprised of any material suitable for use in a molten carbonate fuel cell (MCFC) or solid oxide fuel cell (SOFC) (e.g., high temperature, low temperature, or medium temperature).

FIG. 6 diagrammatically depicts another example reaction 600 in a fuel cell using oxygen as oxidizer gas 602.

In the example reaction 600 of the fuel cell (e.g., direct carbon fuel cell), the oxidizer gas 602 includes oxygen. Transport of the oxide ions from the cathode 504 to the fuel containing anode slurry takes place in a liquid medium, such as molten carbonate. The material of the cathode 504 can include nickel oxide, alternatives including but not limited to lithium cobaltate, and/or lanthanum strontium manganite.

In this reaction, CO₂ gas does not need to be supplied to the cathode 604. The fuel containing molten salt anode slurry contains molten salts, which conduct O²⁻ ions, although the main conducting ion may be a complex oxide such as CO₃²⁻. The reaction at the cathode 604 includes a reduction of molecules of oxygen gas under consumption of four electrons and generation of two oxidizing O²⁻ ions. The molten salt electrolyte is held in a porous ceramic matrix by capillary forces.

The porous ceramic matrix material generally has adequate resistance to corrosion in the molten salt environment. In principle, since molten salt conductivity in this case is related to transport of O²⁻ ions, there is no need to convert O²⁻ ions into CO₃²⁻ as in the previous case. Material for the molten salt anode in this example reaction 600 is the same or similar to the electrolyte materials with high conductivity of oxidizing ions O²⁻. Upon entering the fuel-containing anode slurry, oxidizer ions O²⁻ encounters solid fuel particle and oxidize fuel particles electrochemically with release of four electrons and two molecules of CO₂.

The cathode can be comprised of any material suitable for use in a molten carbonate fuel cell (MCFC) or solid oxide fuel cell (SOFC) (e.g., high temperature, low temperature, or medium temperature).

FIG. 7 illustrates a cross sectional view of a fuel cell sub-stack 700 having cathode 734 and anode collectors 732 electrically coupled to one another.

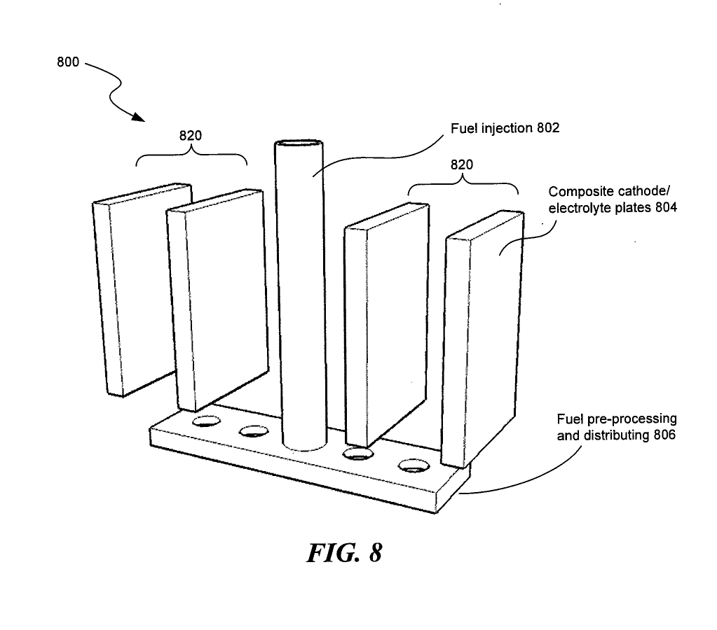

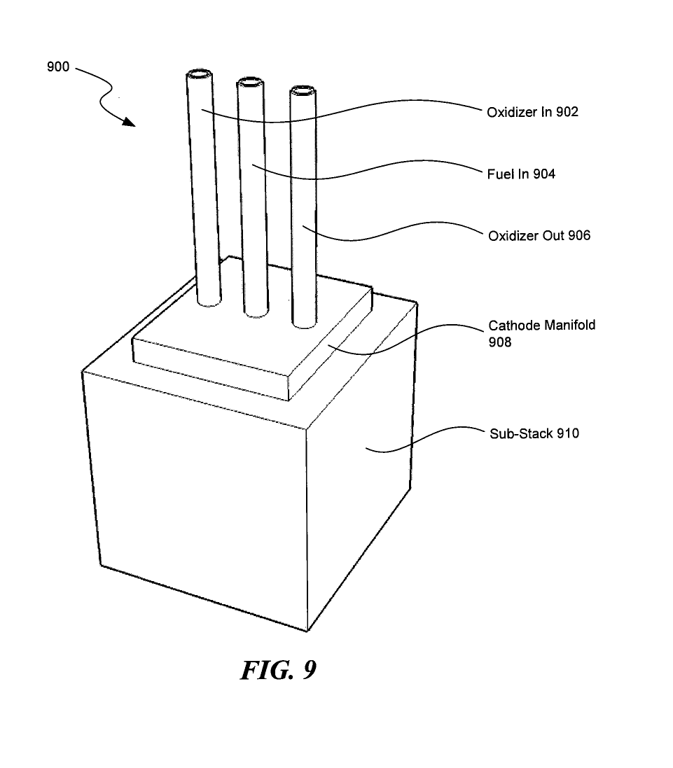

The fuel cells 720 are typically enclosed in a sub-stack vessel/container 712 and may be connected in series or in parallel with one another. The multiple fuel cell sub-stacks may also be electrically coupled in series and in parallel FIG. 8 further illustrates a diagrammatic 3D view of a fuel cell sub-stack 800 having multiple fuel cells 820 with parallel cathode plates 804, a fuel injection channel 802, and/or a fuel distribution channel 806.

The sub-stack 700 includes multiple cells having at least one composite cathode element that is vertically oriented, an anode chamber 714, also vertically oriented and adjacent to the composite cathode element between cathode 734 and anode collectors 732. The composite cathode element is also illustrated with further reference to the example of FIG. 1. In general, the sub-stack 700 includes multiple cathode elements which may also be double sided and positioned vertical in parallel with one another. The anode chambers 714 are comprised in the volume between the cathode elements. In one embodiment, the anode chambers 714 are filled with fuel dispersed in a molten salt slurry. The same molten salt composition can also be used in the porous matrices on the outer layers of the cathode elements.

In one embodiment, the anode chamber 714 also includes an anode current collector 732 and can be positioned vertically in the chamber 714. The anode current collector 732 is typically connected to the chamber 714 in parallel. One embodiment of the cathode element also includes a cathode current collector 734, which receives the electrons generated from fuel oxidation. In on embodiment, the cathode elements are connected electrically in parallel via the anode current collectors 732 and cathode current collectors 734.

The inner core of each cathode plate can be made from, for example, oxidation resistant stainless steel. The material and geometry used can ideally distribute oxidizer gas across the cathode surface evenly, preheat the incoming gas and return depleted gas to the cathode exhaust port. In one embodiment, the cathode current collectors in a sub-stack 700 are connected via a busbar or similar device for uniform distribution of the current drawn from the row of cells in the sub-stack. The fuel distribution channel 716 can include an opening to inject fuel into the anode chamber 714. Similarly, the anode current collectors 732 in a sub-stack are connected in such a way as to ensure a uniform distribution of the current flowing into the rows of cells in the sub-stack.

One embodiment of the sub-stack further includes a fuel injection channel/line 702. The fuel injection channel 702 and the fuel distribution channel 716 together form a fuel injection system which is typically comprised of material that is stable in molten salt. For example, the fuel injection system can comprise of ceramics or ceramic coated alloys. Fuel is injected through the fuel injection system into the lower zone of the sub-stack container and distributed between the vertical plates.

The fuel is finely divided and injected with a stream of carrier gas. Periodic injections of carrier gas without fuel injection may be used to re-distribute fuel uniformly within the anode 714. Pyrolysis of the fuel can be performed in zone 726. Should molten salt or other molten material evaporate, then more salt may be blended with the fuel and injected into the sub-stack 700. The horizontal channel may also serve as an in-situ pyrolysis zone to convert raw biomass, for example, into charcoal like fuel. The geometry of the fuel distribution channel 716 is selected to establish desired conditions for pyrolysis, such as residence time and temperature.

The desired temperature for pyrolysis may be higher than the cell operating temperature—that is, the temperature of the lower part of the sub-stack container is controlled so as to achieve a satisfactory vertical temperature profile in the fuel-molten salt slurry, with the highest temperature maintained in the mixing and pyrolysis zone, and a lower temperature maintained in both the concentration zone and in the anode compartments. Control over this temperature profile is enabled by both external heating (differential heating of parts of the container walls) and temperature of the injected gas-and-solid stream. Components of the fuel injection and ash/mineral matter separation systems may also serve as a support for the vertical cathode plates.

The uniformity of the fuel distribution is ensured by proper design of the fuel/anode recycle gas distributor and a fuel distribution channel 716 by optimizing number and geometry of perforations at the top of fuel distribution channel.

The lower zone of the sub-stack 700 serves as a zone for the separation and concentration of ash and mineral matter contained in the fuel. For example, the sub-stack 700 can include an ash/mineral matter separator. The matter or ash originally present in the fuel can sink to the bottom of the anode chamber 714 and accumulate in ash/mineral matter concentration zone because the density of these materials is higher than that of the molten salt. The ash and mineral matter can be withdrawn periodically through removal port 730 connected to grooves at the bottom of the cell from the ash/mineral matter separator. The design of the separator can be optimized by providing profiles and baffle plates such that ash and mineral matter can accumulate and be directed to the removal ports. One embodiment of the fuel cells include a withdrawal port 728 to remove slag from the anode 714. Another embodiment includes a withdrawal port to remove any floating slag that accumulates on the upper surface of the molten slurry anode.

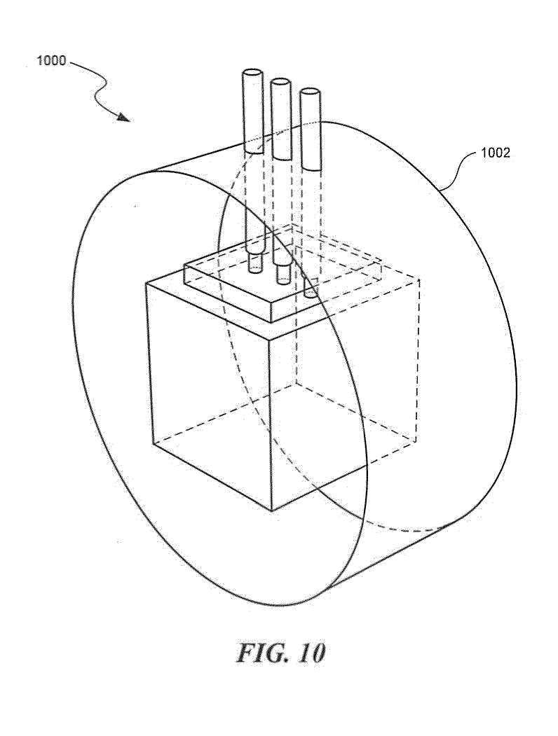

FIG. 10 illustrates a diagrammatic view of a fuel cell sub-stack 1000 having a thermal insulator 1002.

In one embodiment, the sub-stack 1000 is surrounded by thermal insulation 1002. The shape of insulation may also be square, or rectangular, and in general as any other shape depending on the container geometry.

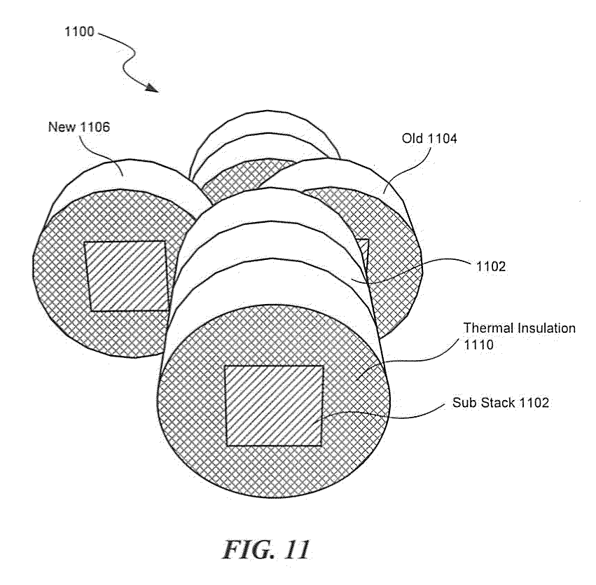

FIG. 11 illustrates a diagrammatic view of a fuel cell stack 1100 having multiple sub-stacks 1102 that are replaceable online.

The fuel cell stack 1100 includes multiple sub-stacks 1102 each of which may include thermal insulation 1110. The fuel cell sub-stacks 1102 are electrically coupled to one another (e.g., in series or in parallel) and the multiple fuel cell sub-stacks can include multiple fuel cells electrically coupled to one another. In general, as illustrated with further reference to the example of FIG. 7, each of the fuel cell typically includes a composite cathode element that is vertically oriented and an anode chamber coupled to the composite cathode element.

In one embodiment, one or more of the sub-stacks 1102 is replaceable online. Such online replacement capability can reduce the total lifetime capital cost of the system. For example, an old or malfunctioned fuel cell sub-stack 1104 can be replaced with a new sub-stack 1106 without taking the stack 1100 offline. Similarly, if the sub-stack 1102 needs to be inspected or upgraded, the sub-stack 1102 can be removed without affecting the functionality of the other sub-stacks. Sub-stacks may contain direct carbon fuel cells or molten carbonate fuel cells. Alternatively, some sub-stacks in the stack may contain molten carbonate fuel cells and some sub-stacks in the same stack may contain direct carbon fuel cells.

One embodiment of the fuel cell stack 1100 includes additional stacks without fuel cells. For example, the stack 1100 can further include a thermal insulation structure connected to one end of the fuel cell stack and/or another thermal insulation structure connected to another end of the fuel cell stack. The subs-stacks 1102 can be held together by an external structure, such as a frame. In general, the fuel cell stack 1100 may vary in size and electric output, for example, between ˜5 kW-500 kW.

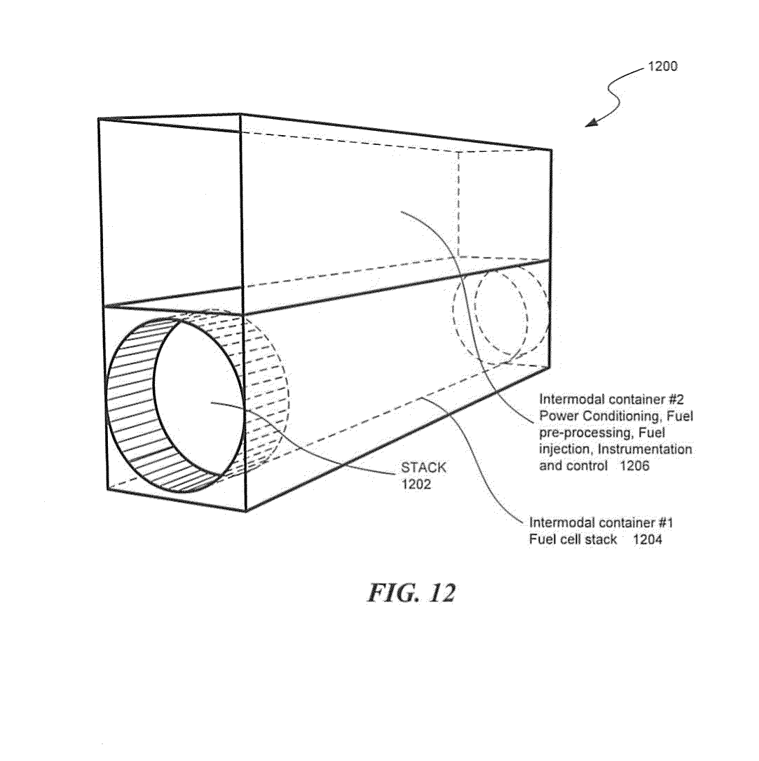

FIG. 12 illustrates a diagrammatic view of a fuel cell stack 1202 integrated with auxiliary equipment into a stand-alone power generator 1200.

An example integration of a fuel cell stack into a power generator shown in FIG. 12. The power generator can also include auxiliary equipment such as a fuel supply system, an oxidizer supply system, power management/distribution system, and/or instrumentation and control system. The fuel supply system distributes solid or semi-solid as well as liquid fuel from the fuel bin to each sub-stack and may include optional components for in-situ fuel pre-treatment. The fuel cell stack typically includes multiple sub-stacks that are electrically connected to one another in series or in parallel. In one embodiment, the sub-stacks are removable and may be replaced during operation or maintenance shutdown periods.

The oxidizer supply system can distribute oxidizer gas or a mixture of gases including oxidizer gas to each sub-stack. The power management and distribution system establishes electrical connection of cells, sub-stacks, and stacks with disconnection or bypassing of individual components such as cells, sub-stacks, and stacks to maximize power output or efficiency of energy conversion.

The power management and distribution system can also perform conversion of direct current (DC) electricity generated by cells into user desired AC (alternating current) or DC outputs, for example by DC/DC step-up or DC/AC conversion. The instrumentation and control system monitors electrical parameters (current and voltage), temperature, and consumption rates of fuel and oxidizer. The instrumentation and control system synchronizes the operation of the fuel supply, oxidizer supply, and power management and distribution systems.

In one embodiment, a shipping container may be used to accommodate stacks and other balance-of-plant components. For instance, two shipping containers can be used: one container 1204 for accommodating fuel cell stack 1202 and another container 1206 for accommodating electrical and mechanical balance of plant and optional fuel pre-processing and/or storage.

The components can be factory assembled and delivered to installation site. Typically, the power generator has a small foot print, and produces no pollution and uses solid fuel and air to operate. These features allow deployment at any location, including urban, rural, industrial, remote areas, etc. Such a power generator can be used as a local power-source-cum-CO₂-concentrator.

In one embodiment, fuels are biomass, waste derived fuels, coal, coke, and heavy oil. In case of using liquid hydrocarbons, they have to be converted in situ into solid carbon-rich particles, which may be accomplished inside molten media comprising the anode chamber.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A system of a fuel cell stack, the system, comprising:
multiple fuel cell sub-stacks electrically coupled to one another, the multiple fuel cell sub-stacks including multiple fuel cells electrically coupled to one another enclosed in a sub-stack vessel;
wherein, each of the multiple fuel cell sub-stacks is replaceable online.

2. The system of claim 1, wherein, each of the multiple fuel cells comprises:
a composite cathode element;
an anode chamber containing multiple composite cathode elements;
wherein, the composite cathode element and the anode chamber are oriented such that dispersion of injected fuel through a fuel cell anode is caused at least in part by buoyancy force.

3. The system of claim 1, wherein, each of the multiple fuel cells in a sub-stack are connected in parallel.

4. The system of claim 1, wherein, each of the multiple fuel cells in a sub-stack are connected in series.

5. The system of claim 1, wherein, each of the multiple fuel cells in a sub-stack are connected in parallel and in series.

6. The system of claim 2, wherein, the anode chamber occupies interstices between composite cathode elements.

7. The system of claim 2,
wherein, in operation, fuel injected into the fuel cell is oxidized in the anode chamber by oxidizer ions generated at the composite cathode element and transported to the anode chamber through electrolyte;
wherein, the oxidizer ions are generated from oxidizer gas which enters through the cathode element, the oxidizer gas comprising a mixture of oxygen or air and 0% or more % of carbon dioxide.

8. The system of claim 2,
wherein, the composite cathode element comprises an air or oxygen inlet, a second inlet for carbon dioxide injection, an open space to allow the inlet gases to distribute along internal cathode surfaces, and an outlet.

9. The system of claim 8, wherein, the cathode current collector is disposed within the open space.

10. A system of a fuel cell stack, the system, comprising:
multiple fuel cell sub-stacks electrically coupled to one another, the multiple fuel cell sub-stacks including multiple fuel cells electrically coupled to one another each enclosed in a sub-stack vessel;
wherein, each of the multiple fuel cell sub-stacks includes a fuel injection system having a fuel injection channel and a fuel distribution channel;
wherein, each of the multiple fuel cells comprises:
a composite cathode element that is substantially vertically oriented;
an anode chamber containing multiple composite cathode elements, the anode chamber being substantially vertically oriented.

11. The system of claim 10,
wherein, the composite cathode element comprises a cathode current collector;
wherein, in operation, fuel injected into the fuel cell is oxidized in the anode chamber by oxidizer ions generated at the composite cathode element and transported to the anode chamber through the electrolyte;
wherein, the oxidizer ions are generated from oxidizer gas which enters through the cathode element, the oxidizer gas comprising a mixture of oxygen or air and 0% or more % of carbon dioxide.

12. The system of claim 11, wherein, the cathode current collector is disposed within the open space.

13. The system of claim 11, wherein, the composite cathode element further comprises a cathode structure to achieve the addition of electrons to one or more of, oxygen atoms and CO₂ molecules, and an external porous structure attached to an external surface of the composite cathode structure.

14. A system of a fuel cell stack, the system, comprising:
multiple fuel cell sub-stacks electrically coupled to one another, the multiple fuel cell sub-stacks include multiple fuel cells electrically coupled to one another enclosed in a sub-stack vessel;
wherein, each of the multiple fuel cell sub-stacks includes a fuel injection system having a fuel injection channel and a fuel distribution channel;
wherein, each of the multiple fuel cells comprises:
a composite cathode element;
wherein, the composite cathode element comprises a cathode current collector;
an anode chamber surrounding composite cathode elements;
wherein, each of the multiple fuel cell sub-stacks is replaceable online.
